(19) United States
(12) Patent Application Publication
(10) Pub. No.: US 2005/0142037 A1
(43) Pub. Date: Jun. 30, 2005

(54) Hydrophobic surface with a plurality of electrodes

(76) Inventor: Karsten Reihs, Koln (DE)

Correspondence Address: PERMAN & GREEN, 425 POST ROAD, FAIRFIELD, CT, 06824, US

(21) Appl. No.: 10/499,607

(22) PCT Filed: Dec. 17, 2002
(86) PCT No.: PCT/EP02/14393

(30) Foreign Application Priority Data
Dec. 17, 2001 (DE) 10162188.4

(51) Int. Cl. B01L 3/02

(52) U.S. Cl. 422/100

(57) ABSTRACT

The invention relates to a device for manipulating minuscule fluid drops with an open-top ultraphobic surface. Said device comprises a grid with essentially evenly spread electrodes in the area of the hydrophobic surface. An electric field can be generated by means of said electrodes. At least one electrode can be controlled by an automated control device for a specific period of time with a given voltage in such a way that each fluid drop follows a very specific path at a very specific speed on the ultraphobic surface.

The present invention relates to an apparatus for manipulating minuscule fluid drops with an open-top ultraphobic surface, which apparatus, in the area of the hydrophobic surface, comprises a grid with substantially uniformly distributed electrodes with which an electric field may in each case be generated and in which at least one electrode may in each case simultaneously be actuated individually for a specific period with an electrical voltage by an automated control unit in such a manner that the fluid drops in each case proceed over the ultraphobic surface along a very specific track at a very specific speed.

The present invention furthermore relates to a method for setting down fluid drops, a method for displacing fluid drops, a method for locating fluid drops and a method for determining the size of a fluid drop.

Chemical analysis and the manipulation of minuscule fluid drops, which have a volume of the order of magnitude of 10⁻¹² to 10⁻⁶ litres or a diameter of the order of magnitude of approx. 0.01 to 1 mm, are becoming increasing significant in biotechnology. In such applications, fluid drops must, for example, be displaced along very specific tracks in order to pass through different locations for analysis or in order to be combined with other fluid drops. Such displacement may, for example, be achieved by electric fields generated by a plurality of electrodes which are arranged along the track to be followed by the fluid drop. Such an apparatus is disclosed, for example, in WO 99/54730, said apparatus comprising a hydrophobic surface on which a fluid drop may be guided along a certain track by a specific arrangement of electrodes. This apparatus has the disadvantage, however, that a new apparatus must be provided every time the track is modified.

The object of the present invention was accordingly to provide an apparatus which does not exhibit the disadvantages of the prior art.

Said object is achieved by an apparatus for manipulating minuscule fluid drops with an open-top ultraphobic surface which apparatus, in the area of the ultraphobic surface, comprises a grid with substantially uniformly distributed electrodes with which an electric field may in each case be generated and in which at least one electrode may in each case simultaneously be actuated individually for a specific period with an electrical voltage by an automated control unit in such a manner that the fluid drops in each case proceed over the ultraphobic surface along a very specific track at a very specific speed.

For the person skilled in the art, it was utterly surprising and unexpected that it should be possible using the apparatus according to the invention to displace a fluid drop along any desired track at a very specific speed. The track may be reprogrammed by the automated control device after each use or during use, such that the apparatus according to the invention may be used for virtually any application in which minuscule fluid drops have to be manipulated or analysed. Should the fluid drop deviate from its desired track, the track may be corrected by modifying the programming. The apparatus according to the invention is simple and economic to manufacture.

For the purposes of the invention, manipulation means displacing a fluid drop, holding a fluid drop in a very specific location, mixing a fluid drop, dividing a fluid drop and combining two or more fluid drops. A fluid drop for the purposes of the invention consists of any desired liquid and preferably exhibits a volume of 10⁻¹² to 10⁻⁶ l, particularly preferably of 10⁻⁹ to 10⁻⁵ l.

According to the invention, the apparatus has an open-top, ultraphobic surface. For the purposes of the invention, open-top does not mean that the apparatus according to the invention cannot be temporarily covered, for example with a preferably ultraphobic lid. An ultraphobic surface for the purposes of the invention is distinguished in that the contact angle of a water drop lying on the surface is more than 150° and the roll-off angle does not exceed 10°. The roll-off angle is taken to mean the angle of inclination of a basically planar but textured surface relative to horizontal at which a stationary water drop with a volume of 10 μl is set in motion by gravity when the surface is inclined. Such ultraphobic surfaces are, for example, disclosed in WO 98/23549, WO 96/04123, WO 96/21523, WO 00/39369, WO 00/39368, WO 00/39239, WO 00/39051, WO 00/38845 and WO 96/34697, which are hereby introduced as references and are accordingly deemed to be part of the disclosure.

In a preferred embodiment, the ultraphobic surface has a surface topography in which the spatial frequency f of the individual Fourier components and their amplitudes a(f) expressed by the integral S(log f)=a(f)·f, calculated between the integration limits log (f₁/μm⁻¹)=−3 and log (f₁/μm⁻¹)=3, is at least 0.3 and which consists of a hydrophobic or in particular oleophobic material or of a durably hydrophobised or in particular durably oleophobised material. Such an ultraphobic surface is described in international patent application WO 99/10322, which is hereby introduced as a reference and is accordingly deemed to be part of the disclosure.

The apparatus according to the invention furthermore comprises a grid with substantially uniformly distributed electrodes, with which an electric field may in each case be generated. The grid preferably comprises at least 16×16=256, particularly preferably at least 64×64=4096 and very particularly preferably at least 256×256=65536 electrodes. The electrodes are in each case individually connectable to an electrical voltage source of preferably 10 to 1000 V, particularly preferably of 100 to 300 V, such that an electric field may be generated with each electrode independently of the other electrodes. The electrodes are preferably arranged at a spacing of <100 μm, particularly preferably of <50 μm and highly preferably of <10 μm. Their largest dimension is preferably ≦150 μm, particularly preferably <70 μm and very particularly preferably <20 μm.

According to the invention, the voltage source is controlled by an automated control unit, for example a computer, and the individual electrodes are thus individually supplied with electrical voltage. The computer establishes which electrode is supplied with electrical voltage at which instant and for how long. In this manner, it is possible to establish the track followed by a fluid drop on a hydrophobic surface and its speed. Actuation of the electrodes by the automated control unit may be modified at any time, such that an apparatus may be adapted for any conceivable application.

In a preferred embodiment of the present invention, not just one but preferably several electrodes, preferably at least two, particularly preferably at least four electrodes, are actuated simultaneously. When two electrodes are actuated, they are preferably adjacent to one another and when four electrodes are actuated they are preferably arranged in a square.

The electrodes are preferably arranged close to the surface of a support. This support is preferably adhesively bonded with a film having an ultraphobic surface. This embodiment has the advantage that the film can be changed after each experiment without having to replace the support and the electrodes or to clean the surface.

In a preferred embodiment of the present invention, the apparatus comprises a removable lid, such that losses of the fluid drops located on the ultraphobic surface are reduced. The apparatus preferably additionally comprises a fluid reservoir which is preferably filled with a liquid which is as similar as possible to the fluid of the fluid drops located on the ultraphobic surface. This preferred embodiment of the present invention ensures that evaporative losses of the fluid drops are virtually eliminated.

The present invention also provides a method for setting down fluid drops with the apparatus according to the invention, in which:
an electric field is generated with at least one electrode,
in each case a fluid drop is deposited on the ultraphobic surface and
the fluid drop is immobilised by the electric field.

By means of the method according to the invention, it is possible durably but reversibly to store a plurality of minuscule fluid drops on an apparatus with an ultraphobic surface, for example for automated analysis or also merely for storage purposes. The fluid drops are located at an unambiguously defined point, such that it is entirely straightforward, for example for an analytical apparatus, to be directed towards the fluid drops and to take samples or to analyse them contactlessly.

In a preferred embodiment of the method according to the invention, the drop is dispensed by a metering pump onto the ultraphobic surface and attracted by the electric field which has been generated by at least one electrode of the grid.

Preferably, two or more fluid drops are set down each at different points on the ultraphobic surface.

Before and/or after being set down, the fluid drops are mixed, purified, combined and/or divided.

The present invention also provides a method for displacing fluid drops with the apparatus according to the invention, in which:
the track and the speed of a fluid drop on the ultraphobic surface is programmed with the automated control unit,
an electric field is generated with at least one electrode,
the fluid drop is set down on the ultraphobic surface and the electrodes along the predetermined track are actuated in such a manner that the fluid drop is displaced at the predetermined speed and is preferably held at its desired final position.

This method has the advantage that a fluid drop may be displaced along any desired track and a very specific speed. The track may be reprogrammed by the automated control device after each use or during use, such that the method according to the invention may be used for virtually any application in which minuscule fluid drops have to be manipulated or analysed. Should the fluid drop deviate from its desired track, the track may be corrected by modifying the programming. The method according to the invention is simple and economic to implement.

The present invention also provides a method for locating fluid drops with the apparatus according to the invention in which the electrical voltage between in each case two electrodes in the vicinity of the fluid drop is modified, preferably periodically, and the variable change in current and the phase shift between the periodic current change and the voltage change is measured. In those electrodes which are located in the immediate vicinity of a fluid drop, the current will be higher than in the other electrodes, such that it is possible on the basis of these measurements to determine the precise location of a fluid drop. The person skilled in the art will recognise that the finer is the electrode grid, the greater will be the accuracy of locating the fluid drop.

Due to the accurate determination of the coordinates of the fluid drop, analytical instruments may be positioned rapidly and accurately thereover or, if fluid drops are to be combined, a second drop may be moved to precisely the position of the first drop.

The present invention also provides a further method for locating fluid drops on a surface, in which light is emitted from a light source and the position of the fluid drop is determined on the basis of the reflected portions of the light. The light sources preferably comprise light guides, preferably of a diameter of <1000 μm, particularly preferably of <100 μm, which are arranged in a regular grid and illuminate the drops on the surface. The reflected portions of the light are also determined by the same light guides.

Due to the accurate determination of the position of the fluid drop, analytical instruments may be positioned rapidly and accurately thereover or, if fluid drops are to be combined, a second drop may be moved to precisely the position of the first drop. A fluid drop may be evaporated on the apparatus according to the invention.

The present invention also provides a method for locating fluid drops which is a combination of the two above-stated methods for locating fluid drops.

The position of the fluid drop is preferably additionally also determined by an optical microscope.

Due to the accurate determination of the position of the fluid drop, analytical instruments may be positioned rapidly and accurately thereover or, if fluid drops are to be combined, a second drop may be moved to precisely the position of the first drop.

The present invention additionally provides a method for determining the size of a fluid drop with the apparatus according to the invention, in which the electrical voltage between in each case two electrodes close to the fluid drop is modified, preferably periodically, and the change in current is measured. The magnitude of the change in current between the pairs of in each case two electrodes, and the phase shift between the periodic voltage change and current change, is a measure of the size of the drop, as the greater is the volume of the fluid drop lying between the electrodes during the measurement, the greater is the current.

Using the method according to the invention, it is possible accurately to determine the size and thus the volume of a drop. This may be of great significance for evaluation of an analysis or for mixing of two or more drops in a very specific ratio.

The present invention also provides another method for determining the size of a fluid drop with a light source, in which light is emitted from at least one light source and the size of the fluid drop is determined on the basis of the reflected portions. To this end a fluid drop, the position of which is known, is illuminated with a light source, preferably a light guide. On the basis of the intensity of the reflected light, which is preferably determined by the same light guides, and by comparative measurements with fluid drops of a known volume, it is possible to ascertain the size of the drop.

Using the method according to the invention, it is possible accurately to determine the size and thus the volume of a drop. This may be of great significance for evaluation of an analysis or for mixing of two or more drops in a very specific ratio.

The present invention also provides a process for determining the size of a fluid drop on a surface, which is a combination of the two above-stated methods.

In the method according to the invention, the size of a drop is preferably additionally determined by an optical microscope.

Using the method according to the invention, it is possible accurately to determine the size and thus the volume of a drop. This may be of great significance for evaluation of an analysis or for mixing of two or more drops in a very specific ratio.

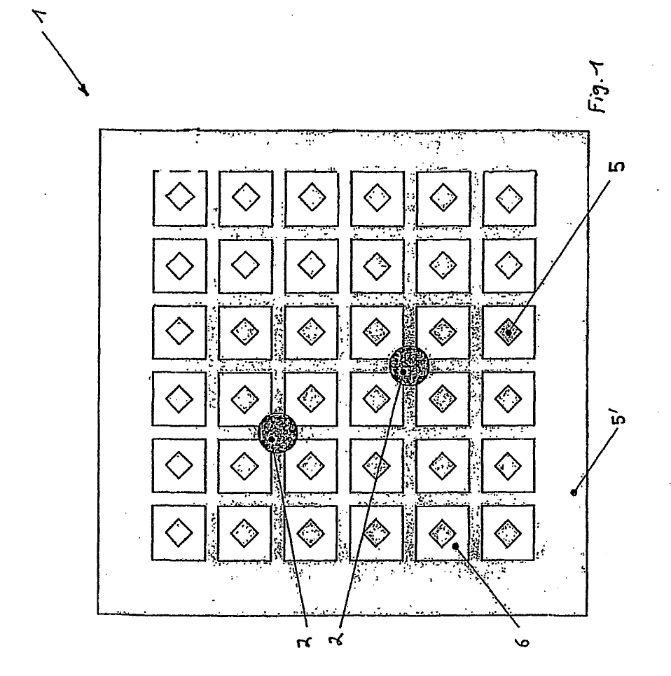

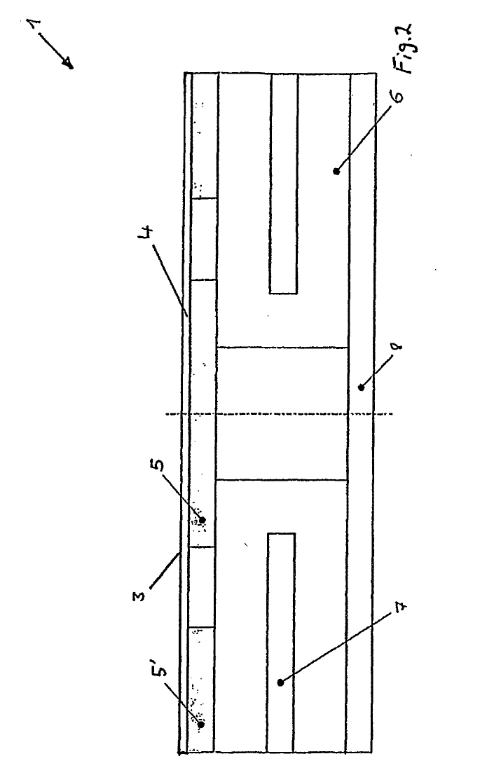

The invention is explained with reference to FIGS. 1 and 2 below. These explanations are given merely by way of example and do not restrict the general concept of the invention.

FIG. 1 is a plan view of the apparatus according to the invention.

FIG. 2 is a section through an electrode in the apparatus according to the invention.

FIG. 1 shows the apparatus 1 according to the invention, which in the present case comprises 36 electrodes 5 and a counter-electrode 5′. The electrodes are arranged in a uniform grid. The spacing of the electrodes is 450 μm, while the edge length of the square electrodes is 150 μm. In the present example, in each case four electrodes 5 are simultaneously actuated with a voltage of 85 V by a computer, such that a fluid drop aligns itself at the vertices of in each case four electrodes. The electrodes are covered by a film 4, which has an ultraphobic surface 3. In the present case, the ultraphobic surface is a surface on which a drop has a contact angle of 174° and a roll-off angle of 3°.

FIG. 2 shows a section through an electrode. The electrode consists of an electrode 5 and a counter-electrode 5′. A dieletric material 6 and shielding 7 are furthermore arranged in the area of the electrode. The electrode comprises connection means 8 in the centre thereof, with which it is connected with a voltage source (not shown), which is controlled by a computer (not shown).

1. An apparatus for manipulating minuscule fluid drops with an open-top ultraphobic surface which apparatus is characterised in that, in the area of the ultraphobic surface, it comprises a grid with substantially uniformly distributed electrodes with which an electric field may in each case be generated, and in that at least one electrode may in each case simultaneously be actuated individually for a specific period with an electrical voltage by an automated control unit in such a manner that the fluid drops in each case proceed over the ultraphobic surface along a very specific track at a very specific speed.

2. An apparatus according to claim 1, characterised in that two or more electrodes may simultaneously be actuated.

3. An apparatus according claim 1, characterised in that the period is of such a length that a drop is kept in the zone of the actuated electrode(s) for this period.

4. An apparatus according to claim 1, characterised in that at least 2, preferably at least 4, electrodes are simultaneously actuated.

5. An apparatus according to claim 1, characterised in that the electrodes are arranged at a spacing of ≦100 μm and in that the largest dimension thereof is preferably ≦150 μm.

6. An apparatus according to claim 1, characterised in that the ultraphobic surface has a surface topography in which the spatial frequency f of the individual Fourier components and their amplitudes a(f) expressed by the integral S(log (f))=a(f)·f, calculated between the integration limits log (f₁/μm⁻¹)=−3 and log (f₁/μm⁻¹)=3, is at least 0.3, and which consists of ultraphobic polymers or durably ultraphobic materials.

7. An apparatus according to claim 1, characterised in that the ultraphobic surface is a preferably self-adhesive film.

8. An apparatus according to claim 1, characterised in that it comprises a fluid reservoir.

9. An apparatus according to claim 1, characterised in that it comprises a removable lid.

10. A method for setting down fluid drops with an apparatus for manipulating minuscule fluid drops with an open-top ultraphobic surface which apparatus is characterised in that, in the area of the ultraphobic surface, it comprises a grid with substantially uniformly distributed electrodes with which an electric field may in each case be generated, and in that at least one electrode may in each case simultaneously be actuated individually for a specific period with an electrical voltage by an automated control unit in such a manner that the fluid drops in each case proceed over the ultraphobic surface along a very specific track at a very specific speed, characterised in that:
an electric field is generated with at least one electrode,
in each case a fluid drop is deposited on the ultraphobic surface and
the fluid drop is immobilised by the electric field.

11. A method according to claim 10, characterised in that the drop is dispensed by a metering pump onto the ultraphobic surface and is attracted by the electric field.

12. A method according to claim claim 10, characterised in that two or more fluid drops are set down each at different points on the ultraphobic surface.

13. A method according to claim 10, characterised in that the fluid drops are mixed, combined, and/or divided.

14. A method for displacing fluid drops with an apparatus for manipulating minuscule fluid drops with an open-top ultraphobic surface which apparatus is characterised in that, in the area of the ultraphobic surface, it comprises a grid with substantially uniformly distributed electrodes with which an electric field may in each case be generated, and in that at least one electrode may in each case simultaneously be actuated individually for a specific period with an electrical voltage by an automated control unit in such a manner that the fluid drops in each case proceed over the ultraphobic surface along a very specific track at a very specific speed characterised in that:
a track and a speed of a fluid drop (2) on the ultraphobic surface (3) is programmed with the automated control unit,
an electric field is generated with at least one electrode,
the fluid drop is set down on the ultraphobic surface (3) and the electrodes along the predetermined track are actuated in such a manner that the fluid drop is displaced at the predetermined speed and is preferably held at its desired final position.

15. A method for locating fluid drops with an apparatus for manipulating minuscule fluid drops with an open-top ultraphobic surface which apparatus is characterised in that, in the area of the ultraphobic surface, it comprises a grid with substantially uniformly distributed electrodes with which an electric field may in each case be generated, and in that at least one electrode may in each case simultaneously be actuated individually for a specific period with an electrical voltage by an automated control unit in such a manner that the fluid drops in each case proceed over the ultraphobic surface along a very specific track at a very specific speed, characterised in that the electrical voltage between in each case two of the electrodes in the vicinity of a fluid drop is modified, preferably periodically, and the change in current and, preferably, the phase shift between the periodic voltage change and current change is measured.

16. A method for locating fluid drops on a surface, characterised in that light is emitted with at least one light source and the position of the fluid drop is determined on the basis of the reflected portions.

17. A method for locating fluid drops on a surface, with an apparatus characterized in that the electrical voltage between in each case two of the electrodes in the vicinity of a fluid drop is modified, preferably periodically, and the change in current and, preferably, the phase shift between the periodic voltage change and current change is measured characterized in that light is emitted with at least one light source and the position of the fluid drop is determined on the basis of the reflected portions.

18. A method according to claim 17, characterised in that the fluid drops are additionally located by an optical microscope.

19. A method for determining the size of a fluid drop with an apparatus for manipulating minuscule fluid drops with an open-top ultraphobic surface which apparatus is characterised in that, in the area of the ultraphobic surface, it comprises a grid with substantially uniformly distributed electrodes with which an electric field may in each case be generated, and in that at least one electrode may in each case simultaneously be actuated individually for a specific period with an electrical voltage by an automated control unit in such a manner that the fluid drops in each case proceed over the ultraphobic surface along a very specific track at a very specific speed, characterised in that the electrical voltage between in each case two electrodes in the vicinity of the fluid drop is modified, preferably periodically, and the variable change in current and, preferably, the phase shift between the periodic current change and the voltage change is measured, this being a measure of the size of the drop.

20. A method for determining the size of a fluid drop with a light source characterised in that light is emitted with at least one light source and the size of the fluid drop is determined on the basis of the reflected portions, it being necessary to know the precise position of the light source.

21. A method for determining the size of a fluid drop on a surface with an apparatus characterized in that the electrical voltage between in each case two electrodes in the vicinity of the fluid drop is modified, preferably periodically, and the variable change is current and, preferably, the phase shift between the periodic current change and the voltage change is measured, this being a measure of the size of the drop, characterized in that light is emitted with at least one light source and the size of the fluid drop is determined on the basis of the reflected portions, it being necessary to know the precise position of the light source.

22. A method according to claim 21, characterised in that the fluid drops are additionally measured by an optical microscope.
